(19) United States
(12) Patent Application Publication
(10) Pub. No.: US 2025/0053638 A1
(43) Pub. Date: Feb. 13, 2025

(54) MATCHING SYSTEM, MATCHING METHOD AND MATCHING PROGRAM

(71) Applicant: NEC Corporation, Minato-ku, Tokyo (JP)

(72) Inventors: Haruna FUKUDA, Tokyo (JP); Toshiyuki ISSHIKI, Tokyo (JP); Kengo MORI, Tokyo (JP); Hiroto TAMIYA, Tokyo (JP)

(73) Assignee: NEC Corporation, Minato-ku, Tokyo (JP)

(21) Appl. No.: 18/722,706

(22) PCT Filed: Dec. 27, 2021
(86) PCT No.: PCT/JP2021/048721

§ 371 Date: Jun. 21, 2024

(51) Int. Cl. G06F 21/46; G06F 17/16

(52) U.S. Cl. CPC G06F 21/46; G06F 17/16

(57) ABSTRACT

A matching system that uses a matching apparatus to match registered information input to a first transformation apparatus and matching information input to a second transformation apparatus, wherein the first transformation apparatus generates a registered feature vector from the registered information, generates a registered concealed vector through calculating a product of the registered feature vector and the registration key matrix by using a regular matrix selected at random as a registration key matrix, and transmits the registered concealed vector to the matching apparatus, the second transformation apparatus generates a matching feature vector from the matching information, generates a matching concealed vector through calculating a product of the matching feature vector and an inverse matrix of the registration key matrix, and transmits the matching concealed vector to the matching apparatus, the matching apparatus calculates an inner product of the registered concealed vector and the matching concealed vector.

### TECHNICAL FIELD

The present invention relates to a matching system, a matching method and a matching program.

### BACKGROUND ART

Biometric authentication is an example of personal authentication. The Biometric authentication is a personal authentication technique that verifies whether or not a person to be authenticated matches a registered person by comparing biometric information of the person to be authenticated with that of the registered person. Here, the biometric information is data extracted from some characteristics of an individual with respect to his or her body and behavior. For example, the biometric information includes extracted features from images such as fingerprints or palm prints, as well as features extracted from audio data like voiceprints.

In biometric authentication, the biometric information of a person to be authenticated is registered in advance, and at the time of authentication, it is verified whether or not the registered biometric information and the biometric information of the person to be authenticated match. In this case, the biometric information must be managed in highly secure manner. This is because since the biometric information is also personal information, the leak itself is harmful, and since the biometric information cannot be destroyed or updated when it is leaked, the security of all authentication systems that use the same biometric information will be lost. Therefore, as protection criteria for biometric information, it is required that the original biometric information cannot be obtained even by the server administrator, and that the registered biometric information can be invalidated.

One matching scheme that satisfies these requirements is cancelable biometrics. The cancelable biometrics is a scheme for matching extracted features from a biological body, in a transformed state. In the cancelable biometrics, at a time of registration, a transformation T←FK(x) is performed on feature x using a registration key K. At a time of matching, a transformation T′←GK′(x) is performed on feature y using a matching key K′. Then, the matching between the feature x and y is performed by matching the transformed T and T′.

By adopting such a scheme, according to the cancelable biometrics, it is possible to invalidate (cancel) a registered data and update it with a new registered data by changing the registration key K and the matching key K′. In addition, since the registered data and/or the matching data are obtained by transforming features using keys, even a server administrator cannot obtain the original biometric information as long as the transformation is sufficiently unidirectional. This means that it has a property suitable for biometric authentication. Various schemes of such cancelable biometrics are known (see, for example, Patent Literatures (PTLs) 1 and 2 and Non-Patent Literature (NPL) 1).

### CITATION LIST

### Patent Literature

[PTL 1]Japanese Patent No. 4961214
[PTL 2]Japanese Patent No. 4929136

### Non Patent Literature

[NPL 1]Y. Saito, I. Nakamura, S. Shiota and H. Kiya, “An Efficient Random Unitary Matrix for Biometric Template Protection,” 2016 Joint 8th International Conference on Soft Computing and Intelligent Systems (SCIS) and 17th International Symposium on Advanced Intelligent Systems (ISIS), 2016, pp. 366-370

### SUMMARY

### Technical Problem

Each disclosure of the literatures in Citation List above is incorporated herein in its entirety by reference thereto. The following analysis is given by the present inventors.

More security is also required for the cancellable biometrics scheme. One of reasons for this is that unidirectionality of transformation is insufficient for some cancelable biometrics in the prior art. If the transformation is unidirectional, original features cannot be uniquely identified from the registered data or the matching data. However, there is a possibility that the registered data and/or the matching data leak(s) information about the original features. In such cases, it has the vulnerability that the original features can be inferred from the registered data and/or the matching data.

It is also possible that a pair of registered data and/or the matching data and the original features may be leaked. In such a case, the registration key or the matching key may be estimated from the pair of registered data and/or matching data and original features. It is preferable that security is ensured even if the pair of registered data and/or matching data and original features is leaked. In addition, in general cancelable biometrics a registration key is often used as a matching key. This means that if either the registration key or the matching key leaks, the other key will also leak.

In view of the above-mentioned problems, it is an object of the present invention to provide a matching system, a matching method and a matching program which contribute to improve security of the cancellable biometrics.

### Solution to Problem

According to a first aspect of the present invention, there is provided a matching system that uses a matching apparatus to match registered information input to a first transformation apparatus and matching information input to a second transformation apparatus, wherein
the first transformation apparatus generates a registered feature vector from the registered information, generates a registered concealed vector through calculating a product of the registered feature vector and the registration key matrix by using a regular matrix selected at random as a registration key matrix, and transmits the registered concealed vector to the matching apparatus,
the second transformation apparatus generates a matching feature vector from the matching information, generates a matching concealed vector through calculating a product of the matching feature vector and the matching key matrix by using an inverse matrix of the registration key matrix as the matching key matrix, and transmits the matching concealed vector to the matching apparatus,
the matching apparatus matches the registered information and the matching information through calculating an inner product of the registered concealed vector and the matching concealed vector.

According to a second aspect of the present invention, there is provided a matching method for matching registered information and matching information, including:
generating a registered feature vector from the registered information;
generating a registered concealed vector through calculating a product of the registered feature vector and a registration key matrix by using a regular matrix selected at random as the registration key matrix;
generating a matching feature vector from the matching information;
generating a matching concealed vector through calculating a product of the matching feature vector and a matching key matrix by using an inverse matrix of the registration key matrix as the matching key matrix, and
matching the registered information and the matching information through calculating an inner product of the registered concealed vector and the matching concealed vector.

According to a third aspect of the present invention, there is provided a matching program executed by a computer that matches registered information input and matching information input including;
generating a registered feature vector from the registered information;
generating a registered concealed vector through calculating a product of the registered feature vector and a registration key matrix by using a regular matrix selected at random as the registration key matrix;
transmitting the registered concealed vector to the matching apparatus;
generating a matching feature vector from the matching information;
generating a matching concealed vector through calculating a product of the matching feature vector and a matching key matrix by using an inverse matrix of the registration key matrix as the matching key matrix;
transmitting the matching concealed vector to the matching apparatus; and
matching the registered information and the matching information through calculating an inner product of the registered concealed vector and the matching concealed vector by the matching apparatus.

Further, this program can be stored in a computer-readable storage medium.

The storage medium may be a non-transitory one such as a semiconductor memory, a hard disk, a magnetic recording medium, an optical recording medium, and the like. The present invention can also be realized as a computer program product.

### Advantageous Effects of Invention

According to each aspect of the present invention, it becomes possible to provide a matching system, a matching method and a matching program which contribute to improve security of the cancellable biometrics.

### BRIEF DESCRIPTION OF THE DRAWINGS

FIG. 1 is a drawing illustrating a schematic configuration of a matching system according to a first example embodiment.

FIG. 2 is a system flow diagram illustrating a first transformation method according to the first example embodiment.

FIG. 3 is a system flow diagram illustrating a second transformation method according to the first example embodiment.

FIG. 4 is a drawing illustrating an example of a hardware configuration of an apparatus used for example embodiments.

FIG. 5 is a drawing illustrating an extended example of a registered feature vector and a matching feature vector.

### EXAMPLE EMBODIMENTS

Example embodiments of the present invention will be described with reference to the drawings. The present invention, however, is not limited to the example embodiments described below. Further, in each drawing, the same or corresponding elements are appropriately designated by the same reference signs. It should also be noted that the drawings are schematic, and the dimensional relationships and the ratios between the elements may differ from the actual ones. The dimensional relationships and the ratios between drawings may also be different in some sections.

### First Example Embodiment

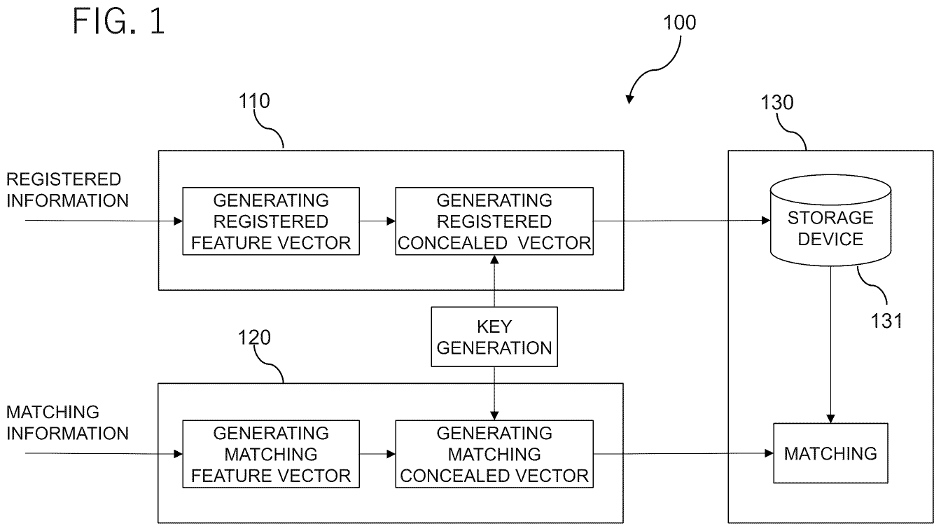

FIG. 1 is a drawing illustrating a schematic configuration of a matching system according to a first example embodiment. As illustrated in FIG. 1. a matching system 100 matches a registered information input to a first transformation apparatus 110 and a matching information input to a second transformation apparatus 120 using a matching apparatus 130. It is possible to unite (or integrate) the first transformation apparatus 110 and the second transformation apparatus 120 into one device, but it is also possible to make the first transformation apparatus 110 and the second transformation apparatus 120 independent devices. The first transformation apparatus 110 and the second transformation apparatus 120 are described here as separate devices to facilitate explanation of their functions.

The first transformation apparatus 110 generates a registered feature vector of order n (n is a given natural number) from the registered information. For example, registered information includes features extracted from images such as face iris, fingerprints, palm prints, and veins of fingers and palms, and features extracted from audio data such as voiceprints. Patterns such as fingerprints and palm prints have distinctive patterns called minutiae. The first transformation apparatus 110 may generates the registered feature vector using these minutiae digitalized. The registered feature vector may be generated by simply arranging features extracted from the registered information, but it is possible to devise a configuration of the registered feature vector as described below.

The first transformation apparatus 110 uses a regular matrix randomly selected as a registration key matrix and generates a registered concealed vector through calculating a product of the registered feature vector and the registration key matrix. Here, the product of the registered feature vector and the registration key matrix is a product of a matrix and a vector as linear algebra. An order of the regular matrix is the same as an order of the registered feature vector. If the order of the registered feature vector is n (n is a natural number), the regular matrix is an n×n matrix.

A method for selecting the regular matrix at random is, for example, to prepare a list of n×n dimensional regular matrices from which one is selected and obtained uniformly at random. Another method includes, for example, to select and obtain one from square matrices in which random numbers of the squares of n (n is a natural number) are assigned to each element and non-regular matrices are excluded therefrom. To exclude non-regular matrices, for example, matrices whose determinant is zero may be excluded. The random number assigned to each element may be a so-called pseudo random number sequence. The pseudo random number sequence a₁, a₂, . . . , aₘ is generally generated by performing deterministic calculation on seeds input, and is configured in such a way that it is substantially impossible to predict aₘ from a₁, a₂, . . . , aₘ₋₁.

It is possible to use real numbers for each value of the feature and the matrix. In other words, if real numbers are used for original features, inner products of the features can be calculated using those real numbers, with almost no loss of accuracy. It is also possible to use integers in a certain range for each value of the feature and the matrix. This is because in modular calculations, in which a modulus p is a prime number, results of addition, subtraction, and multiplication can be remainders of results of usual addition, subtraction, and multiplication divided by p, respectively, and an inverse number can be defined as a number whose remainder, obtained by dividing the result of multiplication by p, is 1 to calculate an inverse matrix. When integers in a certain range are used, each value of the feature is multiplied by a constant and then rounded to an integer, so that it can be made greater than or equal to the maximum possible value of the inner product of the feature rounded as modulus p. This allows the inner product thereof to be calculated with little degradation in accuracy.

The first transformation apparatus 110 transmits the registered concealed vector generated as described above to the matching apparatus 130 and registers it in a storage device 131 provided in the matching apparatus 130. The storage device 131 may be provided inside of the matching apparatus 130, or the storage device 131 may be provided outside of the matching apparatus 130.

The second transformation apparatus 120 generates a matching feature vector form the matching information. The method for generating the matching feature vector from the matching information is the same as the method for generating the registered feature vector from the registered information. That is, the matching feature vector is generated from features extracted from the matching information.

The second transformation apparatus 120 uses an inverse matrix of the registration key matrix generated as described above as a matching key matrix, and generates a matching concealed vector through calculating a product of the matching feature vector and the matching key matrix. The product of the matching feature vector and the matching key matrix is also a product of a matrix and a vector as linear algebra, the same as the product of the registered feature vector and the registration key matrix. The second transformation apparatus 120 differs from the first transformation apparatus 110 in that it uses the matching key matrix, which is the inverse matrix of the registration key matrix, instead of the registration key matrix, which is used to generate the registered concealed vector. However, as mentioned above, the first transformation apparatus 110 and the second transformation apparatus 120 can be united (or integrated) into one device.

The second transformation apparatus 120 transmits the matching concealed vector generated as described above to the matching apparatus 130.

The matching apparatus 130 calculates the inner product of the matching concealed vector, which is received from the second transformation apparatus 120, and the registered concealed vector, which is registered in the storage device 131. As described below, a calculation of this inner product corresponds to a calculation of the inner product of the registered feature vector and the matching feature vector. The inner product of the registered feature vector and the matching feature vector indicates a similarity between the registered information and the matching information. Therefore, if the similarity is within a predetermined range, the registered information can be judged to match the matching information. The matching result between the registered information and the matching information can be transmitted by the matching apparatus 130 to the second transformation apparatus 120, or it can be used as a trigger for another process.

The principle by which the matching system 100 described above functions is explained hereinafter.

First, a registration key matrix is denoted as A. The registration key matrix A is a regular matrix of n×n selected at random. On the other hand, when a matching key matrix is denoted as B, the matching key matrix B is an inverse matrix of the registration key matrix, therefore, B=Δ⁻¹ holds.

A registered feature vector generated from registered information is denoted as x, and a matching feature vector generated from matching information is denoted as y. Then, a registered concealed vector t is a product of the registered feature vector x and the registration key matrix A, therefore, t=A^{T}x holds, and a matching concealed vector s is a product of the matching feature vector and the matching key matrix B, therefore, s=Bx holds. Note that the subscript T indicates that it is a transposed matrix. When calculation of the inner product is expressed as a product of matrices, it is necessary to transpose one of the matrices. For this reason, the transposition is performed in advance.

When matching, an inner product of the registered concealed vector t and the matching concealed vector s is calculated. Considering that the matching key matrix B is the inverse of the registration key matrix A, the inner product of the matching concealed vector and the registered concealed vector matches an inner product of the registered feature vector x and the matching feature vector y, as follows.

$$〈 {A}^{T} x , By 〉 = {( {A}^{T} x )}^{T} ( By ) = {x}^{T} ( AB ) y = {x}^{T} y = 〈 x , y 〉$$

The inner product <x, y> of the registered feature vector x and the matching feature vector y is an index indicating a similarity. For example, normalized correlation is often used as the index indicating a similarity for vectors. The normalized correlation of two vectors x=(x₁, x₂, . . . , xₙ)^{T} and y=(y₁, y₂, . . . , yₙ)^{T} is defined as following formula. This normalized correlation indicates similarity if it is large, and dissimilarity if it is small. As can be seen from the definition given by the following formula, if the two vectors x and y are normalized, the normalized correlation is an inner product itself. Therefore, if the registered feature vector x and the matching feature vector y are normalized, the inner product <x, y> of the registered feature vector x and the matching feature vector y can be used as the index indicating a similarity.

$$\sum {x}_{i} {y}_{i} / \sqrt{\sum {x}_{i}^{2} {y}_{i}^{2}} \qquad [ Math . 1 ]$$

For example, a Euclidean distance is also often used as an index indicating a similarity for vectors. The Euclidean distance of two vectors x=(x₁, x₂, . . . , xₙ)^{T} and y=(y₁, y₂, . . . , yₙ)^{T} is defined as following formula. This Euclidean distance indicates similarity if it is small, and dissimilarity if it is large. As can be seen from the definition given by the following formula, an inner product of two vectors x′=(Σxᵢ², 1, x₁, x₂, . . . , xₙ)^{T} and y′=(1, Σyᵢ², −2y₁, −2y₂, . . . , −2yₙ)^{T} is the Euclidean distance itself. Therefore, if the registered feature vector and the matching feature vector are x′ and y′, respectively, for two vectors x and y for which the Euclidean distance is to be calculated, the inner product <x′, y′> of the registered feature vector x′ and the matching feature vector y′ can be used as an index indicating a similarity (i.e., the Euclidian distance between the two vectors x and y).

$$\sum {( {x}_{i} - {y}_{i} )}^{2} = \sum {x}_{i}^{2} + \sum {y}_{i}^{2} + \sum ( - 2 {x}_{i} {y}_{i} ) \qquad [ Math . 2 ]$$

For example, a Hamming distance is also often used as an index of a similarity for binary vectors (i.e., vectors whose elements are 0 or 1). The Hamming distance of two vectors x=(x₁, x₂, . . . , xₙ)^{T} and y=(y₁, y₂, . . . , yₙ)^{T} is defined as the following formula. This Hamming distance indicates similarity if it is small, and dissimilarity if it is large. As can be seen from the definition given by the following formula, an inner product of two vectors x′=(1, x₁, x₂, . . . , xₙ)^{T} and y′(Σyᵢ², 1−2y₁, 1−2y₂, . . . , 1−2yₙ)^{T} is the Hamming distance itself. Therefore, if the registered feature vector and the matching feature vector are x′ and y′, respectively, for two vectors x and y for which the Hamming distance is to be calculated, the inner product <x′, y′> of the registered feature vector x′ and the matching feature vector y′ can be used as an index indicating a similarity (i.e., the Hamming distance between the two vectors x and y).

$$\sum \vert {x}_{i} - {y}_{i} \vert = \sum {y}_{i} + \sum {x}_{i} ( 1 - 2 {y}_{i} ) \qquad [ Math . 3 ]$$

Next, it is explained that the matching system 100 described above can update a key.

An other regular matrix Δ selected at random is prepared. This regular matrix Δ is also an n×n matrix like the registration key matrix and the matching key matrix. In the key update, this other regular matrix Δ is multiplied by the registration key matrix and the matching key matrix, respectively. Concretely, for the original registration key matrix Δ, a new registration key matrix is to be AA, and for the original matching key matrix B, a new matching key matrix is to be Δ⁻¹B.

Even with the new registration key matrix Δ A and the new matching key matrix Δ⁻¹B updated in this way, a calculation result of an inner product of the registered concealed vector (AΔ)^{T}x and the matching concealed vector Δ⁻¹By will match the inner product of the registered feature vector x and the matching feature vector y.

$$〈 {( A Δ )}^{T} x , {Δ}^{- 1} By 〉 = {( {( A Δ )}^{T} x )}^{T} ( {Δ}^{- 1} By ) = {x}^{T} ( A {ΔΔ}^{- 1} B ) y = {x}^{T} ( AB ) y = {x}^{T} y = 〈 x , y 〉$$

In addition, in the key update, the registered concealed vector that has already been registered will be also updated. The registered feature vector that has already been registered is concealed using the original registration key matrix A. Therefore, the registered concealed vector that has already been registered is updated so that it can be matched using the new matching key matrix Δ⁻¹B. Concretely, when the registered concealed vector that is concealed using the original registration key matrix A is A^{T}x, an updated registered concealed vector is Δ^{T}(A^{T}x). The fact that this updated registered concealed vector Δ^{T}(A^{T}x) is the same as the one concealed using the new registration key matrix AΔ can be understood from the fact that

$${Δ}^{T} ( {A}^{T} x ) = {Δ}^{T} {A}^{T} x = {( A Δ )}^{T} x .$$

In this way, in the key update in the matching system 100, an old registered feature vector (the registered feature vector which has already been registered) is updated by multiplying the registered feature vector A^{T}x which has already been registered by an other regular matrix Δ selected at random so that it can be matched using a new matching key matrix Δ⁻¹B. Thus, in the matching system 100 of this example embodiment, when it is necessary to invalidate a registered feature vector, which has already been registered, due to an unforeseen situation such as an information leakage, the old registered feature vector (the registered feature vector which has already been registered) is updated so that it cannot be matched unless a new matching key matrix is used. Note that invalidation here means that it is impossible to determine whether or not registered concealed vectors and/or matching concealed vectors, which are generated using different keys, are generated from the same feature, if there is no other information leakage.

### (Matching Method)

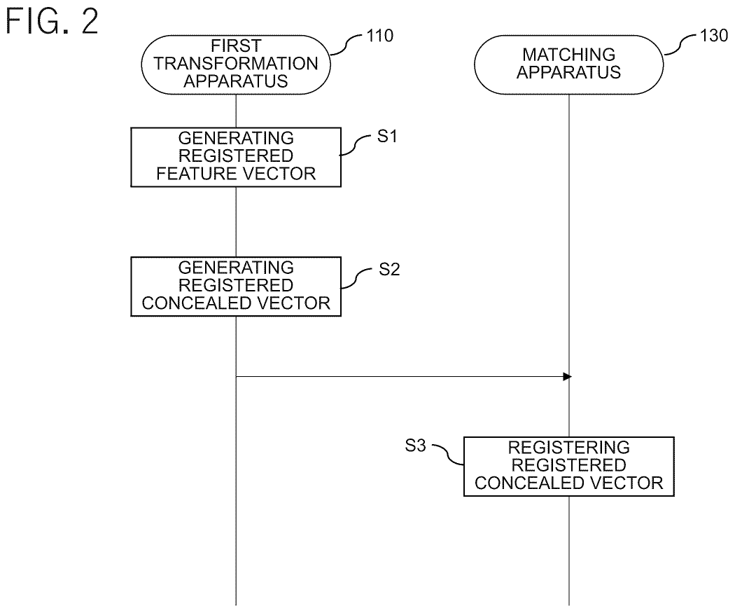

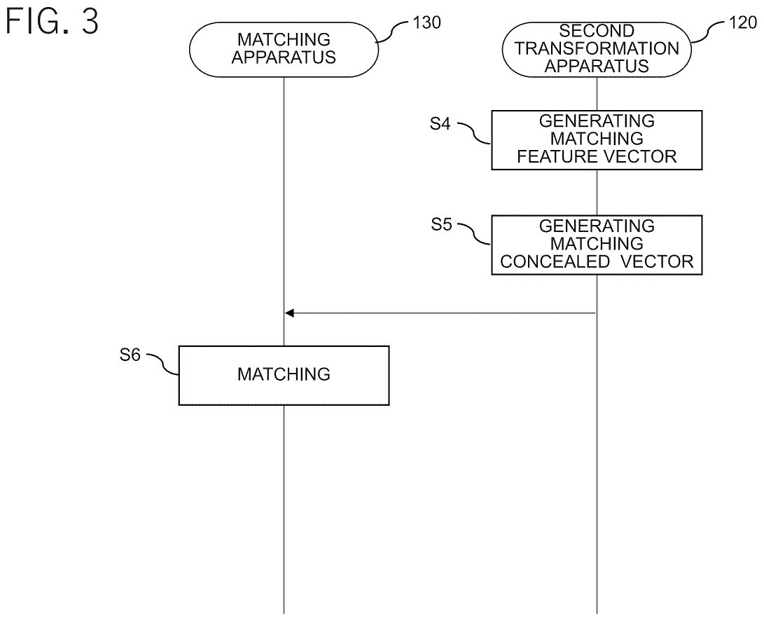

FIG. 2 and FIG. 3 are system flow charts illustrating a matching method according to the first example embodiment. The matching method illustrated in FIG. 2 and FIG. 3 is a matching system in which a registered information input to the first transformation apparatus 110 and a matching information input to the second transformation apparatus 120 are matched using the matching apparatus 130. The first transformation apparatus 110 and the second transformation apparatus can be united (or integrate) into one device. A first transformation method illustrated in FIG. 2 and a second transformation method illustrated in FIG. 3 can be repeated independently and in any order. That is, the first transformation method illustrated in FIG. 2 can be repeated as many times as the number of registered information to be registered, and the second transformation method illustrated in FIG. 3 can be performed at any timing that requires authentication of matching information.

As illustrated in FIG. 2, steps S1 through S3 are executed when performing the first transformation method according to the first example embodiment. In step S1, the first transformation apparatus 110 generates a registered feature vector from registered information. The registered feature vector may be generated by simply arranging features extracted from the registered information, but it is possible to devise a configuration of the registered feature vector as described below.

Next, in step S2, the first transformation apparatus 110 generates a registered concealed vector through calculating a product of the registered feature vector and the registration key matrix by using a regular matrix selected at random as the registration key matrix. A configuration of the registration key matrix has already been explained. The first transformation apparatus 110 transmits the registered concealed vector generated to the matching apparatus 130.

Next, in step S3, the matching apparatus 130 registers the registered concealed vector received from the first transformation apparatus 110 in the storage device 131. As mentioned above, steps S1 through S3 can be repeated as many times as the number of registered information to be registered.

On the other hand, as illustrated in FIG. 3, steps S4 through S6 are executed when performing the second transformation method according to the first example embodiment. In step S4, the second transformation apparatus 120 generates a matching feature vector from matching information. The method for generating the matching feature vector from the matching information is the same as the method for generating the registered feature vector from the registered information.

Next, in step S5, the second transformation apparatus 120 generates a matching concealed vector through calculating a product of the matching feature vector and a matching key matrix by using an inverse matrix of the registration key matrix generated as described above as the matching key matrix. A relationship between the registration key matrix and the matching key matrix and a configuration of the matching key matrix have already been explained. The second transformation apparatus 120 transmits the matching concealed vector generated to the matching apparatus 130.

Finally, in step S6, the matching apparatus 130 matches the registered information and the matching information through calculating an inner product of the matching concealed vector received from the second transformation apparatus 120 and the registered concealed vector registered in the storage device 131.

Thus, it is possible to combine the first transformation method illustrated in FIG. 2 and the second transformation method illustrated in FIG. 3 to implement the first example embodiment as a matching method.

### (Example of Hardware Configuration)

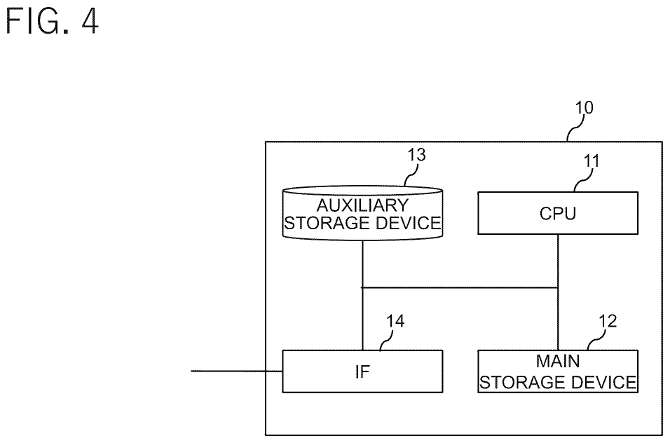

FIG. 4 is a drawing illustrating an example of a hardware configuration of apparatuses used for the example embodiments. In other words, the first transformation apparatus 110, the second transformation apparatus 120, and the matching apparatus 130 make information processing apparatus(es) (computer(s)) employing the hardware configuration illustrated in FIG. 4 execute matching method described above as programs to be able to achieve each function of the first transformation apparatus 110, the second transformation apparatus 120, and the matching apparatus 130. It should be noted that the hardware configuration example illustrated in FIG. 4 is merely an example of the hardware configuration that achieves the functions of the first transformation apparatus 110, the second transformation apparatus 120, and the matching apparatus 130 and is not intended to limit the hardware configuration of the first transformation apparatus 110, the second transformation apparatus 120, and the matching apparatus 130. The first transformation apparatus 110, the second transformation apparatus 120, and the matching apparatus 130 may include hardware not illustrated in FIG. 4.

As illustrated in FIG. 4, the hardware configuration 10 that may be employed by the first transformation apparatus 110, the second transformation apparatus 120, and the matching apparatus 130 is provided with a CPU (Central Processing Unit) 11, a main storage device 12, an auxiliary storage device 13, and an IF (interface) part 14, which are connected to each other via an internal bus or the like.

The CPU 11 executes each instruction included in programs executed by the first transformation apparatus 110, the second transformation apparatus 120, and the matching apparatus 130. The main storage device 12 is, for example, a RAM (Random Access Memory) and temporarily stores various programs such as the programs executed by the first transformation apparatus 110, the second transformation apparatus 120, and the matching apparatus 130 so that the CPU 11 can process the programs.

The auxiliary storage device 13 is, for example, an HDD (Hard Disk Drive) and is capable of storing the various programs executed by the first transformation apparatus 110, the second transformation apparatus 120, and the matching apparatus 130, or the like, in the medium to long term. The various programs such as the programs may be provided as a program product stored in a non-transitory computer-readable storage medium.

The IF part 14 provides an interface for inputting and outputting among, for example, the first transformation apparatus 110, the second transformation apparatus 120, and the matching apparatus 130.

The information processing apparatus employing the hardware configuration 10 described above achieves the functions of the first transformation apparatus 110, the second transformation apparatus 120, and the matching apparatus 130 by executing the programs described above.

### Second Example Embodiment

The second example embodiment described below is an example embodiment with enhanced security over the first example embodiment. Concretely, in the second example embodiment, leak tolerance of a key is increased over the first example embodiment. For example, if a plurality of pairs of registered feature vector and registered concealed vector corresponded thereof are leaked due to unforeseen situation, a registration key matrix is likely to be inferred from the plurality of pairs of registered feature vector and registered concealed vector leaked. This is also the case when a plurality of pairs of matching feature vector and matching concealed vector is leaked.

A condition that the registration key matrix can be inferred from a plurality of registered feature vectors and registered concealed vectors leaked can be attributed to a condition that simultaneous equations can be solved. A relation between a registered feature vector x, a registered concealed vector t and a registration key matrix Δ is expressed as simultaneous equations A^{T}x=t. Therefore, it can be attributed to the condition that the simultaneous equations can be solved, and the number of known constraint equations≥the number of unknown variables.

Where simultaneous equations A^{T}x=t has n constraint equations and n²+2n variables. The n²+2n variables are the sum of n for the registered feature vector x, n for the registered concealed vector t, and n² for the registration key matrix A.

Of these n²+2n variables, when one registered feature vector x leaks, n variables change from unknown variables to known variables, and when one registered concealed vector t leaks, n variables change from unknown variables to known variables. Furthermore, when k pairs of registered feature vector x and registered concealed vector t are leaked, the number of known constraint equations changes from n to kn. These relationships are summarized in the following table.

TABLE 1

| | number of | |
|---|---|---|
| | known | number of |
| | constraint | unknown |
| leaked data | equations | variables |
| non | | n² + 2n |
| one registered concealed | n | n² + n |
| vector | | |
| registered | | |
| concealed vector | | n² |
| and registered feature vector | | |
| k registered concealed | | n² + kn |
| vectors | | |
| k pairs of registered | kn | n² |
| concealed vector | | |
| and registered feature vector | | |

As can be seen from the above relationships, if the number k of pairs of registered feature vectors and registered concealed vectors to be leaked is satisfied k<n, the registration key matrix is not identified.

However, it can be said that if there are n or more pairs of registered feature vectors and registered concealed vectors to be leaked, there is a possibility that the registration key matrix is identified. Therefore, in the second example embodiment, a following devising is taken to prevent such a situation from occurring.

First, only less than n pairs of registered concealed vectors are to be generated using the same registration key matrix A. If n or more pairs thereof are to be generated, a new registration key matrix A is used. Then, when matching, matching concealed vectors are generated using a matching key matrix corresponding to each registration key matrix, and each matching concealed vector is matched with the registered concealed vector. Furthermore, if the number of times in which matching is performed using the same matching key matrix becomes n or more, there is a possibility that a matching key matrix B leaks from the pair of matching feature vector and matching concealed vector. Therefore, in this case, the key is updated every n−1 times.

The following example shows a case where 100 registered feature vectors are registered and matched when the order n of the registration key matrix and/or registered feature vectors is satisfied n=11.

The registration key matrix used for the 1st to 10th registered feature vectors is A₁, and the registration key matrix used for the 11th to 20th registered feature vectors is A₂. Hereafter in the same manner, and finally, the registration key matrix used for the 91st to 100th registered feature vectors is A₁₀. The registered concealed vectors generated using these registration key matrices are as follows.
A₁^{T}x₁, A₁^{T}x₂, . . . , A₁^{T}x₁₀, A₂^{T}x₁₁, A₂^{T}x₁₂, . . . , A₂^{T}x₂₀, . . . , A₁₀^{T}x₉₁, A₁₀^{T}x₉₂, . . . , A₁₀^{T}x₁₀₀

When matching, a matching concealed vector is generated for one matching feature vector using the matching key matrices B₁, . . . , B₁₀ corresponding to each registration key matrix A₁, . . . , A₁₀. That is, the matching concealed vectors generated from the matching feature vector y are B₁y, B₂y, . . . , B₁₀y. Then, these matching concealed vectors B₁y and each registered concealed vector Aᵢ^{T}xⱼ are matched.

However, if the above matching is repeated 11 or more times, the key may leak. Therefore, every 10 times of matching, regular matrices A₁, . . . , A₁₀ are generated for updating, each registration key matrix Aᵢ is updated to AᵢΔᵢ, each matching key matrix Bᵢ is updated to ΔᵢBᵢ, and each registered concealed vector A₁^{T}xᵢ is updated to Δᵢ^{T}Aᵢ^{T}xᵢ.

In the second example embodiment, the number of registered concealed vectors using the same registration key matrix is reduced below a predetermined natural number n as described above, and the second transformation apparatus updates the matching key matrix so that the number of times, of which matching is performed using the same matching key matrix, does not exceed the predetermined natural number n. This prevents vulnerabilities caused by leakage of n or more pairs of registered feature vectors and registered concealed vectors or n or more pairs of matching feature vectors and matching concealed vectors.

### Third Example Embodiment

The third example embodiment described below is an example embodiment with enhanced security over the first example embodiment. In the matching system described above, the order n of a registered feature vector and the order n of a registration key matrix are the same. Therefore, if a configuration that simply arranges features is adopted for a configuration of the registered feature vector, security, such as leak tolerance of a key, is limited by the number of features. Therefore, in the third example embodiment, a devising is taken to improve security without being limited by the number of features.

When two vectors x′=(r₁, r₂, . . . , rₚ) and y′=(q₁, q₂, . . . , qₚ) are orthogonal to each other, an inner product of x=(x₁, x₂, . . . , xₘ, r₁, r₂, . . . , rₚ) and y=(y₁, y₂, . . . , yₘ, q₁, q₂, . . . , qₚ) is equal to an inner product of X″=(x₁, x₂, . . . , xₘ) and y″=(y₁, y₂, . . . , yₘ).

Therefore, if x″=(x₁, x₂, . . . , xₘ) and y″=(y₁, y₂, . . . , yₘ) are configured with features, and two vectors x′=(r₁, r₂, . . . , rₚ) and y′=(q₁, q₂, . . . , qₚ), which are orthogonal to each other, are added thereto to form a registered feature vector x=(x₁, x₂, . . . , xₘ, r₁, r₂, . . . , rₚ) and a matching feature vector y=(y₁, y₂, . . . , yₘ, q₁, q₂, . . . , qₚ), a value of an inner product remains the same.

For example, two vectors x′ and y′, orthogonal to each other and to be added, can be configured as follows. The first method is that one of x′ and y′ is configured with random numbers for all elements, the other is configured with random numbers for all elements except one element, and the one element remaining is used to adjust the two vectors x′ and y′ so that they are orthogonal to each other. In this method, x′ and y′ are determined at the time of key generation, and the same x′ and y′ are used each time in the registration flow.

The second method is that x′ is configured as a vector arranging q random numbers and p-q zeros and y′ is configured as a vector arranging q zeros and p-q random numbers, where q is between 0 and p inclusive. In this method, q is determined at the time of key generation and pre-setup, and the random numbers in x′ and y′ are selected independently at the time of concealed vector generation.

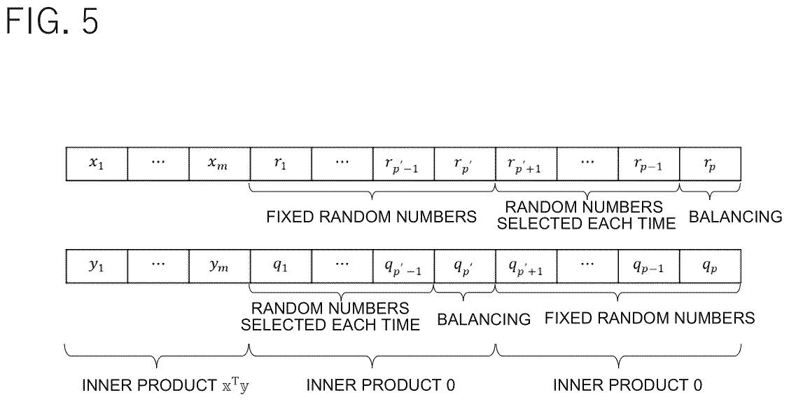

In the third method, as illustrated in FIG. 5, x′ is configured as a vector arranging p′ fixed random numbers, p−p′−1 random numbers which are selected independently each time, and one value for balancing, and y′ is configured as a vector arranging p′−1 random numbers which are selected independently each time, one value for balancing, and p−p′ fixed random numbers, where p′ is between −2 and 2 inclusive. In this method, fixed random number vectors (r₁, r₂, . . . , r_{p′}) and (q_{p′+1}, q_{p′+2}, . . . , qₚ) are determined at the time of key generation and pre-setup. When generating concealed vectors, the random number vectors (r_{p′+1}, r_{p′+2}, . . . , rₚ₋₁) and (q₁, q₂, . . . , q_{p′-1}) are independently selected each time, and rₚ and q_{p′} are selected such that two inner product values <(r₁, r₂, . . . , r_{p′}), (q₁, q₂, . . . , q_{p′})> and <(r_{p′+1}, r_{p′+2}, . . . , rₚ), (q_{p′+1}, q_{p′+2}, . . . , qₚ)> are to be s and −s, respectively. That is, an inner product of the registered feature vector x=(x₁, x₂, . . . , xₘ, r₁, r₂, . . . , rₚ) and the matching feature vector y=(y₁, y₂, . . . , yₘ, q₁, q₂, . . . , qₚ) matches an inner product of x″=(x₁, x₂, . . . , xₘ) and y″=(y₁, y₂, . . . , yₘ).

In other words, even if the order of the feature is m, the order n of the registration key matrix and the matching key matrix can be expanded to m+p by adding an orthogonal vector of order p. In addition, a random number component, which is selected in independently each time, is added to both the registered feature vector and the matching feature vector. This improves the leak tolerance of the key and the original feature vector. The following table shows the leak tolerance of the keys.

TABLE 2

| | number of | |
|---|---|---|
| | known | number of |
| | constraint | unknown |
| leaked data | equations | variables |
| non | m + p | (m + p)² + 2(m + p) |
| one registered concealed | | (m + p)² + m + p |
| vector | | |
| a pair of registered | | |
| concealed vector feature | | (m + p)² |
| and registered | | |
| vector | | |
| k registered concealed | | (m + p)² + k(m + p) |
| vectors | | |
| k pairs of registered | k(m + p) | (m + p)² |
| concealed vector feature | | |
| and registered | | |
| vector | | |

As can be seen from the above relationships, if the number of pairs of registered feature vectors and registered concealed vectors to be leaked, k, and the number of dimensions of random number vectors added to the registered features, p, are satisfied k<m+p, the registration key matrix is not identified. In other words, even if the order of the feature is m, leak tolerance, of which the number of pairs of registered feature vectors and registered concealed vectors to be leaked is up to m+p−1, can be obtained, by adding an orthogonal vector of order p. If the devising of this example embodiment are combined with the second example embodiment, it will be possible to prevent vulnerabilities more efficiently.

### Fourth Example Embodiment

In the fourth example embodiment, the configuration of a registered feature vector and a matching feature vector is devised so that an inner product of the registered feature vector and the matching feature vector is to be a score of registered information and matching information obtained by referring to a score table.

When a score for a feature cannot be expressed in a simple polynomial, a method of giving the score by referring to a score table may be employed. For a vector of features, in the score table, a score is assigned for each value of each element of the vector and the sum of the scores of all elements is a final score.

For example, in the following score table, for vectors (0, 1, 2) and (1, 2, 0), it is to be table (0, 1)=−1, table (1, 2)=1, and table (2, 0)=−1, therefore, score is −1.

TABLE 3

| | 0 | 1 | 2 |
|---|---|---|---|
| 0 | 0 | −1 | −1 |
| 1 | −1 | 2 | 1 |
| 2 | −1 | 1 | 2 |

Even with scoring using such a score table, scores can be calculated by expressing each value of a feature as a vector. For each value of a feature, when 0 is expressed as (1,0,0), 1 as (0,1,0), and 2 as (0,0,1), for example, table(0,1) can be expressed using matrix operations as follows.

$$table ( 0 , 1 ) = ( 1 , 0 , 0 ) ( \begin{matrix}0 & - 1 & - 1 \\ - 1 & 2 & 1 \\ - 1 & 1 & 2\end{matrix} ) ( \begin{matrix}0 \\ 1 \\ 0\end{matrix} ) \qquad [ Math . 4 ]$$

A row of the score table is selected according to a value of a registered feature, their vector representations are concatenated to form a registered feature vector, and those selected from (1,0,0), (0,1,0), and (0,0,1) according to a value of a matching feature are concatenated to form a matching feature vector. Using these, the score can be calculated through calculating an inner product as shown in the following example.

$$\begin{matrix}score ( ( 0 , 1 , 2 ) , ( 1 , 1 , 1 ) ) = \begin{matrix}{( 0 , − 1 , − 1 , − 1 , 2 , 1 , − 1 , 1 , 2 )}^{T} \cdot \\ ( 0 , 1 , 0 , 0 , 1 , 0 , 0 , 1 , 0\end{matrix} \\ = 2\end{matrix}$$

The whole or part of example embodiments disclosed above can be described as, but not limited thereto, the following Supplementary Notes.

### [Supplementary Note 1]

A matching system that uses a matching apparatus to match registered information input to a first transformation apparatus and matching information input to a second transformation apparatus, wherein
the first transformation apparatus generates a registered feature vector from the registered information, generates a registered concealed vector through calculating a product of the registered feature vector and the registration key matrix by using a regular matrix selected at random as a registration key matrix, and transmits the registered concealed vector to the matching apparatus,
the second transformation apparatus generates a matching feature vector from the matching information, generates a matching concealed vector through calculating a product of the matching feature vector and the matching key matrix by using an inverse matrix of the registration key matrix as the matching key matrix, and transmits the matching concealed vector to the matching apparatus,
the matching apparatus matches the registered information and the matching information through calculating an inner product of the registered concealed vector and the matching concealed vector.

### [Supplementary Note 2]

The matching system described in supplementary note 1, wherein the matching apparatus updates the registered feature vector by multiplying the registered feature vector by an other regular matrix selected at random to enable matching using a new matching key matrix.

### [Supplementary Note 3]

The matching system described in supplementary note 2, wherein the first transformation apparatus reduces a number of registered concealed vectors that are generated using the same registration key matrix to less than a predetermined natural number n, the second transformation apparatus updates the matching key matrix so that a number of times of matching that uses the same matching key matrix does not exceed the predetermined natural number n.

### [Supplementary Note 4]

The matching system described in any one of supplementary notes 1 to 3, wherein
the registered feature vector and the matching feature vector are configured that vectors orthogonal to each other are incorporated into respective corresponding elements.

### [Supplementary Note 5]

The matching system described in to any one of supplementary notes 1 to 4, wherein
the registered feature vector and the matching feature vector are configured such that an inner product of the registered feature vector and the matching feature vector is a squared Euclidean distance between the registered information and the matching information.

### [Supplementary Note 6]

The matching system described in any one of supplementary notes 1 to 4, wherein
the registered feature vector and the matching feature vector are configured such that an inner product of the registered feature vector and the matching feature vector is a score of the registered information and the matching information obtained by referring to a score table.

### [Supplementary Note 7]

The matching system described in any one of supplementary notes 1 to 6, wherein
the regular matrix is generated by excluding non-regular matrices from square matrices in which random numbers of a square of a given natural number n are assigned to each element.

### [Supplementary Note 8]

The matching system described in any one of supplementary notes 1 to 7, wherein
the first transformation apparatus and the second transformation apparatus are united into one device.

### [Supplementary Note 9]

The matching system described in any one of supplementary notes 1 to 8, wherein
the matching apparatus includes a storage device that stores the registered concealed vector received from the first transformation apparatus.

### [Supplementary Note 10]

A second transformation apparatus that inquires input matching information to a matching apparatus that stores registered concealed vector, the registered concealed vector being generated through calculating a product of a registered feature vector and a registration key matrix, the registered feature vector being generated from registered information and a regular matrix selected at random being used as the registration key matrix, wherein
the second transformation apparatus generates a matching feature vector from the matching information, generates a matching concealed vector through calculating a product of the matching feature vector and the matching key matrix by using an inverse matrix of the registration key matrix as the matching key matrix, and transmits the matching concealed vector to the matching apparatus, and
the matching apparatus matches the registered information and the matching information through calculating an inner product of the registered concealed vector and the matching concealed vector.

### [Supplementary Note 11]

A first transformation apparatus that registers data on registered information to a matching apparatus that performs matching on an input of a matching concealed vector, the matching concealed vector being generated through calculating a product of a matching feature vector and a matching key matrix, the matching feature vector being generated from matching information and an inverse matrix of a registration key matrix that is a regular matrix selected at random being used as the matching key matrix, wherein
the first transformation apparatus generates a registered feature vector from the registered information, generates a registered concealed vector through calculating a product of the registered feature vector and the registration key matrix by using the registration key matrix, and transmits the registered concealed vector to the matching apparatus, and
the matching apparatus matches the registered information and the matching information through calculating an inner product of the registered concealed vector and the matching concealed vector.

### [Supplementary Note 12]

A matching method for matching registered information and matching information, including:
generating a registered feature vector from the registered information;
generating a registered concealed vector through calculating a product of the registered feature vector and a registration key matrix by using a regular matrix selected at random as the registration key matrix;
generating a matching feature vector from the matching information;
generating a matching concealed vector through calculating a product of the matching feature vector and a matching key matrix by using an inverse matrix of the registration key matrix as the matching key matrix, and
matching the registered information and the matching information through calculating an inner product of the registered concealed vector and the matching concealed vector.

### [Supplementary Note 13]

A second transformation method that inquires input matching information to a matching apparatus that stores a registered concealed vector, the registered concealed vector being generated through calculating a product of a registered feature vector and a registration key matrix, the registered feature vector being generated from registered information and a regular matrix selected at random being used as the registration key matrix, including:
generating a matching feature vector from the matching information;
generating a matching concealed vector through calculating a product of the matching feature vector and a matching key matrix by using an inverse matrix of the registration key matrix as the matching key matrix, and
transmitting the matching concealed vector to the matching apparatus, wherein
the matching apparatus matches the registered information and the matching information through calculating an inner product of the registered concealed vector stored in the storage device and the matching concealed vector.

### [Supplementary Note 14]

A first transformation method that registers data on registered information to a matching apparatus that performs matching on an input of a matching concealed vector, the matching concealed vector being generated through calculating a product of a matching feature vector and a matching key matrix, the matching feature vector being generated from matching information and an inverse matrix of a registration key matrix that is a regular matrix selected at random being used as the matching key matrix, including:
generating a registered feature vector from the registered information;
generating a registered concealed vector through calculating a product of the registered feature vector and a registration key matrix by using the registration key matrix; and
transmitting the registered concealed vector to the matching apparatus, wherein
the matching apparatus matches the registered information and the matching information through calculating an inner product of the registered concealed vector and the matching concealed vector.

### [Supplementary Note 15]

A matching program executed by a computer that matches registered information input and matching information input including;
generating a registered feature vector from the registered information;
generating a registered concealed vector through calculating a product of the registered feature vector and a registration key matrix by using a regular matrix selected at random as the registration key matrix;
transmitting the registered concealed vector to the matching apparatus;
generating a matching feature vector from the matching information;
generating a matching concealed vector through calculating a product of the matching feature vector and a matching key matrix by using an inverse matrix of the registration key matrix as the matching key matrix;
transmitting the matching concealed vector to the matching apparatus; and
matching the registered information and the matching information through calculating an inner product of the registered concealed vector and the matching concealed vector by the matching apparatus.

### [Supplementary Note 16]

An authentication program, executed by a computer, that the computer inquires input matching information to a matching apparatus that stores a registered concealed vector, the registered concealed vector being generated through calculating a product of a registered feature vector and a registration key matrix, the registered feature vector being generated from registered information and a regular matrix selected at random being used as the registration key matrix, including: generating a matching feature vector from the matching information;
generating a matching concealed vector through calculating a product of the matching feature vector and a matching key matrix by using an inverse matrix of the registration key matrix as the matching key matrix, and
transmitting the matching concealed vector to the matching apparatus, wherein
the matching apparatus matches the registered information and the matching information through calculating an inner product of the registered concealed vector stored in the storage device and the matching concealed vector.

### [Supplementary Note 17]

An registration program, executed by a computer, that the computer registers data on registered information to a matching apparatus that performs matching on an input of a matching concealed vector, the matching concealed vector being generated through calculating a product of a matching feature vector and a matching key matrix, the matching feature vector being generated from matching information and an inverse matrix of a registration key matrix that is a regular matrix selected at random being used as the matching key matrix, including:
generating a registered feature vector from the registered information;
generating a registered concealed vector through calculating a product of the registered feature vector and a registration key matrix by using the registration key matrix; and
transmitting the registered concealed vector to the matching apparatus, wherein
the matching apparatus matches the registered information and the matching information through calculating an inner product of the registered concealed vector and the matching concealed vector.

Further, the disclosure of Patent Literature cited above is incorporated herein in its entirety by reference thereto. It is to be noted that it is possible to modify or adjust the example embodiments or examples within the scope of the whole disclosure of the present invention (including the Claims) and based on the basic technical concept thereof. Further, it is possible to variously combine or select (or partially omit) a wide variety of the disclosed elements (including the individual elements of the individual claims, the individual elements of the individual example embodiments or examples, and the individual elements of the individual figures) within the scope of the whole disclosure of the present invention. That is, it is self-explanatory that the present invention includes any types of variations and modifications to be done by a skilled person according to the whole disclosure including the Claims and the technical concept of the present invention. Particularly, any numerical ranges disclosed herein should be interpreted that any intermediate values or subranges falling within the disclosed ranges are also concretely disclosed even without specific recital thereof. In addition, using some or all of the disclosed matters in the literatures cited above as necessary, in combination with the matters described herein, as part of the disclosure of the present invention in accordance with the object thereof shall be considered to be included in the disclosed matters of the present application.

### REFERENCE SIGNS LIST

10: hardware configuration
11: CPU
12: main storage device
13: auxiliary storage device
14: INTERFACE
100: matching system
110: first transformation apparatus
120: second transformation apparatus
130: matching apparatus
131: storage device

What is claimed is:

1. A matching system that uses a matching apparatus to match registered information input to a first transformation apparatus with matching information input to a second transformation apparatus, wherein
the first transformation apparatus generates a registered feature vector from the registered information, generates a registered concealed vector through calculating a product of the registered feature vector and the registration key matrix by using a regular matrix selected at random as a registration key matrix, and transmits the registered concealed vector to the matching apparatus,
the second transformation apparatus generates a matching feature vector from the matching information, generates a matching concealed vector through calculating a product of the matching feature vector and the matching key matrix by using an inverse matrix of the registration key matrix as the matching key matrix, and transmits the matching concealed vector to the matching apparatus,
the matching apparatus matches the registered information with the matching information through calculating an inner product of the registered concealed vector and the matching concealed vector.

2. The matching system according to claim 1, wherein
the matching apparatus updates the registered feature vector by multiplying the registered feature vector by an other regular matrix selected at random to enable matching using a new matching key matrix.

3. The matching system according to claim 2, wherein
the first transformation apparatus reduces a number of registered concealed vectors that are generated using the same registration key matrix to less than a predetermined natural number n,
the second transformation apparatus updates the matching key matrix so that a number of times of matching that uses the same matching key matrix does not exceed the predetermined natural number n.

4. The matching system according to claim 1, wherein
the registered feature vector and the matching feature vector are configured that vectors orthogonal to each other are incorporated into respective corresponding elements.

5. The matching system according to claim 1, wherein
the registered feature vector and the matching feature vector are configured such that an inner product of the registered feature vector and the matching feature vector is a squared Euclidean distance between the registered information and the matching information.

6. The matching system according to claim 1, wherein
the registered feature vector and the matching feature vector are configured such that an inner product of the registered feature vector and the matching feature vector is a score of the registered information and the matching information obtained by referring to a score table.

7. The matching system according to claim 1, wherein
the regular matrix is generated by excluding non-regular matrices from square matrices in which random numbers of a square of a given natural number n are assigned to each element.

8. The matching system according to claim 1, wherein
the first transformation apparatus and the second transformation apparatus are united into one device.

9. The matching system according to claim 1, wherein
the matching apparatus comprises a storage device that stores the registered concealed vector received from the first transformation apparatus.

10-11. (canceled)

12. A matching method for matching registered information with matching information, comprising:
generating a registered feature vector from the registered information;
generating a registered concealed vector through calculating a product of the registered feature vector and a registration key matrix by using a regular matrix selected at random as the registration key matrix;
generating a matching feature vector from the matching information;
generating a matching concealed vector through calculating a product of the matching feature vector and a matching key matrix by using an inverse matrix of the registration key matrix as the matching key matrix, and
matching the registered information with the matching information through calculating an inner product of the registered concealed vector and the matching concealed vector.

13-14. (canceled)

15. A non-transitory computer readable medium storing a matching program executed by a computer that matches registered information input and matching information input comprising;
generating a registered feature vector from the registered information;
generating a registered concealed vector through calculating a product of the registered feature vector and a registration key matrix by using a regular matrix selected at random as the registration key matrix;
transmitting the registered concealed vector to the matching apparatus;
generating a matching feature vector from the matching information;
generating a matching concealed vector through calculating a product of the matching feature vector and a matching key matrix by using an inverse matrix of the registration key matrix as the matching key matrix;
transmitting the matching concealed vector to the matching apparatus; and
matching the registered information and with the matching information through calculating an inner product of the registered concealed vector and the matching concealed vector by the matching apparatus.

16-17. (canceled)

18. The matching method according to claim 12, wherein
the registered feature vector is updated by multiplying the registered feature vector by an other regular matrix selected at random to enable matching using a new matching key matrix.

19. The matching method according to claim 18, wherein
a number of registered concealed vectors that are generated using the same registration key matrix is less than a predetermined natural number n, the matching key matrix is updated so that a number of times of matching that uses the same matching key matrix does not exceed the predetermined natural number n.

20. The matching method according to claim 12, wherein
the registered feature vector and the matching feature vector are configured that vectors orthogonal to each other are incorporated into respective corresponding elements.

21. The matching method according to claim 12, wherein
the registered feature vector and the matching feature vector are configured such that an inner product of the registered feature vector and the matching feature vector is a squared Euclidean distance between the registered information and the matching information.

22. The matching method according to claim 12, wherein
the registered feature vector and the matching feature vector are configured such that an inner product of the registered feature vector and the matching feature vector is a score of the registered information and the matching information obtained by referring to a score table.

23. The non-transitory computer readable medium storing the matching program according to claim 15, wherein
the registered feature vector is updated by multiplying the registered feature vector by an other regular matrix selected at random to enable matching using a new matching key matrix.

24. The non-transitory computer readable medium storing the matching program according to claim 23, wherein
a number of registered concealed vectors that are generated using the same registration key matrix is less than a predetermined natural number n,
the matching key matrix is updated so that a number of times of matching that uses the same matching key matrix does not exceed the predetermined natural number n.

25. The non-transitory computer readable medium storing the matching program according to claim 15, wherein
the registered feature vector and the matching feature vector are configured that vectors orthogonal to each other are incorporated into respective corresponding elements.

26. The non-transitory computer readable medium storing the matching program according to claim 15, wherein
the registered feature vector and the matching feature vector are configured such that an inner product of the registered feature vector and the matching feature vector is a squared Euclidean distance between the registered information and the matching information.
